(19) United States
(12) Patent Application Publication
(10) Pub. No.: US 2009/0100844 A1
(43) Pub. Date: Apr. 23, 2009

(54) Apparatus and method for controlling temperature in a boil-off gas

(75) Inventor: Carl Jorgen Rummelhoff, Moss (NO)

Correspondence Address: YOUNG & THOMPSON, 209 Madison Street, Suite 500, ALEXANDRIA, VA, 22314, US

(73) Assignee: HAMWORTHY GAS SYSTEMS AS, ASKER (NO)

(21) Appl. No.: 10/578,884

(22) PCT Filed: Nov. 11, 2004
(86) PCT No.: PCT/NO2004/000342

§ 371 Date: May 11, 2006

(30) Foreign Application Priority Data
Nov. 13, 2003 (NO) 20035047

(51) Int. Cl. F17C 6/00; F25J 1/02; F17C 13/08

(52) U.S. Cl. 62/48.2; 62/613; 62/53.2

(57) ABSTRACT

An apparatus and method for controlling temperature in a boil-off gas in a liquefaction plant prior to compression, wherein boil-off gas originating from an LNG storage tank is compressed and at least partially condensed, and wherein the condensed boil-off gas (LNG) is being returned to the storage tank. A heat exchanger (20) is connected to the boil-off gas feed line upstream of the compressor (10), and a first conduit (22) fluidly connects the line for returning LNG to the storage tank and the heat exchanger (20). A second conduit (26) fluidly connects the heat exchanger (20) to the boil-off gas feed line at a point upstream of the heat exchanger (20). Boil-off gas is heat exchanged against the cooler (24) prior to being fed into the compressor (10). Thus, the boil-off gas temperature is lowered downstream of the heat exchange.

The invention relates to the field of reliquefaction of boil-off gases in liquid natural gas (LNG) plants, and more specifically to a method and apparatus for controlling the temperature in a boil-off gas.

A common technique for transporting natural gas from its extraction site, is to liquefy the natural gas at or near this site, and transport the LNG to the market in specially designed storage tanks, often placed aboard a sea-going vessel.

The process of liquefying the natural gas involves compression and cooling of the gas to cryogenic temperatures (e.g. −160° C.). The LNG carrier may thus transport a significant amount of liquefied gas to its destination. At this destination, the LNG is offloaded to special tanks onshore, before it is either transported by road or rail on LNG carrying vehicles or revaporized and transported by e.g. pipelines.

LNG boils at slightly above −163° C. at atmospheric pressure, and is usually loaded, transported and offloaded at this temperature. This requires special materials, insulation and handling equipment in order to deal with the low temperature and the boil-off vapour. Due to heat leakage, the cargo (LNG) surface is constantly boiling, generating vaporized natural gas (“boil-off”) from the LNG (e.g. methane).

Plants for the continuous liquefaction of this boil-off gas are well known. The liquefaction of boil-off gases on LNG carriers results in increased cargo deliveries and allows the operator to choose the most optimal carrier propulsion system. LNG carriers have traditionally been driven by steam turbines, and the boil-off gases from the LNG cargo have been used as fuel. This has been considered a costly solution.

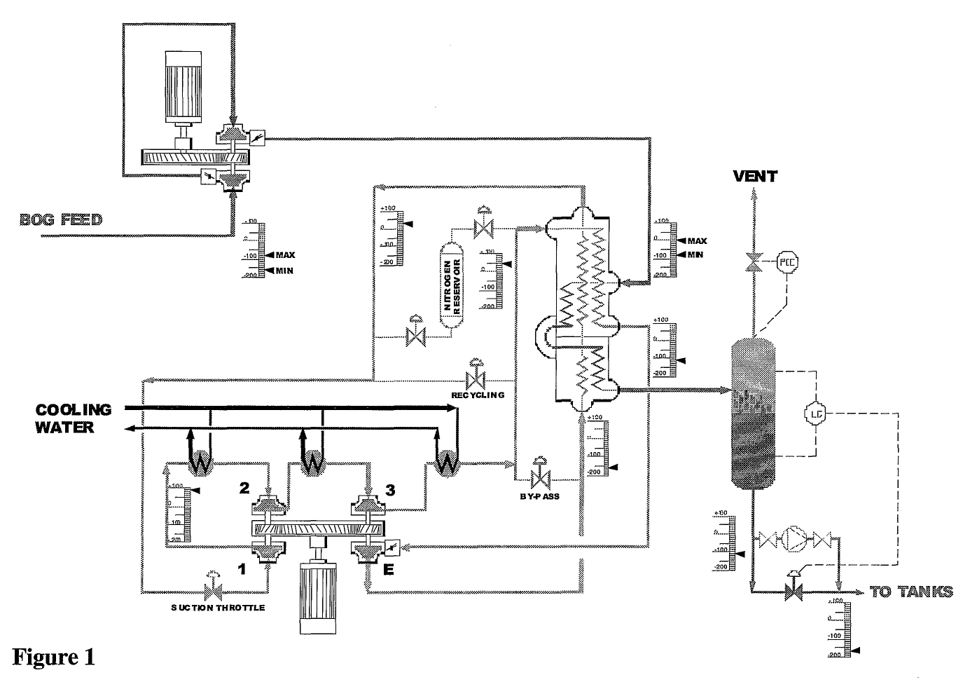

One such alternative to using the boil-off gas as fuel is the Moss RS™ Concept, wherein the boil-off gas is liquefied and the resulting LNG is pumped back to the cargo tanks. The Moss RS™ Concept, illustrated in FIG. 1, is based on a closed nitrogen expansion cycle, extracting heat from the boil-off gas. The flow diagram in FIG. 1 shows all the equipment located in the cargo machinery deck house. Boil-off gas (BOG) is removed from the cargo tanks by two conventional LD compressors operating in series. The BOG is cooled and condensed to LNG in a cryogenic heat exchanger (“cold box”), to a temperature between the saturation temperature for compressed CH₄ and N₂ before being fed into a separator vessel where certain non-condensibles (mainly N₂) is removed. The LNG coming out of the separator is pumped back to the cargo tanks, while the non-condensibles (i.e. gases) are sent to a flare or vent stack. Reference is also made to Norwegian Patent 30 55 25.

European Patent Application EP 1 132 698 A1 discloses a plant for reliquefying compressed vapour, where means are incorporated to mitigate the problems that arise when vapour is returned with condensed natural gas to the LNG storage tank. Liquefied natural gas is stored in an insulated tank, typically forming part of an ocean going tanker. Boiled off vapour is compressed in a compressor and at least partially condensed in a condenser. The resulting condensate is returned to the tank. The vapour is mixed with liquefied natural gas in a mixing chamber upstream of the compressor. The liquefied natural gas so mixed with the vapour in the mixing chamber is taken from the condensate or from the storage tank.

International Patent Application WO 02/095285 discloses an apparatus and a method for controlling the pressure in the cargo tank of an LNG carrier.

As stated above, LNG boils at slightly above −163° C. at atmospheric pressure. Thus, the temperature of the boil-off gas upon entry into the liquefaction plant is typically in the range −140° C. to −100° C. The plant's compressors (e.g. LD compressors) are thus designed for such approximate temperature range.

It has, however, been discovered that the boil-off gas temperature fluctuates considerably, and values far outside the above range are not uncommon. This is particularly the case during the ballast voyage, where the cargo tanks are virtually empty and easily pick up high temperatures. The vapour header running from each of the cargo tanks have some un-insulated areas that cause a significant temperature increase in the boil-off gas. The vapour header is designed for a vapour flow significantly larger than the boil-off gas flow, thus the resident time of the boil-off gas is high in the vapour header and consequently the heat transfer to the gas is accordingly high.

For example, temperatures as high as −40° C. have been recorded at the compressor inlet. Such high temperatures are unfortunate, given that the compressors are designed for much lower temperatures. It is therefore desirable to control the temperature of the boil-off gas prior to its entry into the compressor, to a greater extent that what thus far has been possible and considered necessary.

The present invention meets the above need, in that it provides a method for controlling temperature in a boil-off gas in a liquefaction plant prior to compression, wherein boil-off gas originating from an LNG storage tank is compressed and at least partially s condensed, and wherein said condensed boil-off gas (LNG) is being returned to the storage tank, said method being characterized by heat exchanging boil-off gas with said LNG, wherein the boil-off gas temperature is lowered and said LNG fully evaporated; and controllably mixing said fully evaporated LNG with said boil-off gas.

In one embodiment, the fully evaporated LNG is mixed with said boil-off gas upstream of said heat exchange.

In another embodiment, the fully evaporated LNG is mixed with said boil-off gas during said compression.

In another embodiment, the fully evaporated LNG is mixed with said boil-off gas following said compression.

The present invention thus also provides an apparatus for controlling temperature in a boil-off gas in a liquefaction plant prior to compression, wherein boil-off gas from an LNG storage tank is fed via a feed line into at least one compressor and where the compressed gas is further fed into a heat exchanger for at least partial condensation, and where said condensed boil-off gas (LNG) is being returned to the storage tank via a return line, said apparatus being characterized by a combined mist separator and heat exchanger connected to the the boil-off gas feed line, between the LNG storage tank and the compressor; a first conduit fluidly connecting the line for returning LNG to the storage tank and the combined mist separator and heat exchanger; a second conduit fluidly connecting the combined mist separator and heat exchanger to the boil-off gas feed line; said first and second conduits being fluidly connected via a cooler in said combined mist separator and heat exchanger; and wherein the boil-off gas is heat exchanged against said cooler prior to being fed into said compressor.

In one embodiment, the second conduit is fluidly connects the combined mist separator and heat exchanger to the boil-off gas feed line upstream of said combined mist separator and heat exchanger.

In another embodiment, the second conduit fluidly connects the combined mist separator and heat exchanger to the boil-off gas feed line after the first compression stage of said compressor.

In another embodiment, the second conduit fluidly connects the combined mist separator and heat exchanger to the boil-off gas feed line downstream of said compressor.

Preferred embodiments of the method and the apparatus of the invention are described in the dependent claims.

Embodiments of the invention will now be described in more detail, with reference to the accompanying drawings, where like parts have been given like reference numbers.

FIG. 1 illustrates a prior art LNG reliquefaction system, as described in the introduction above.

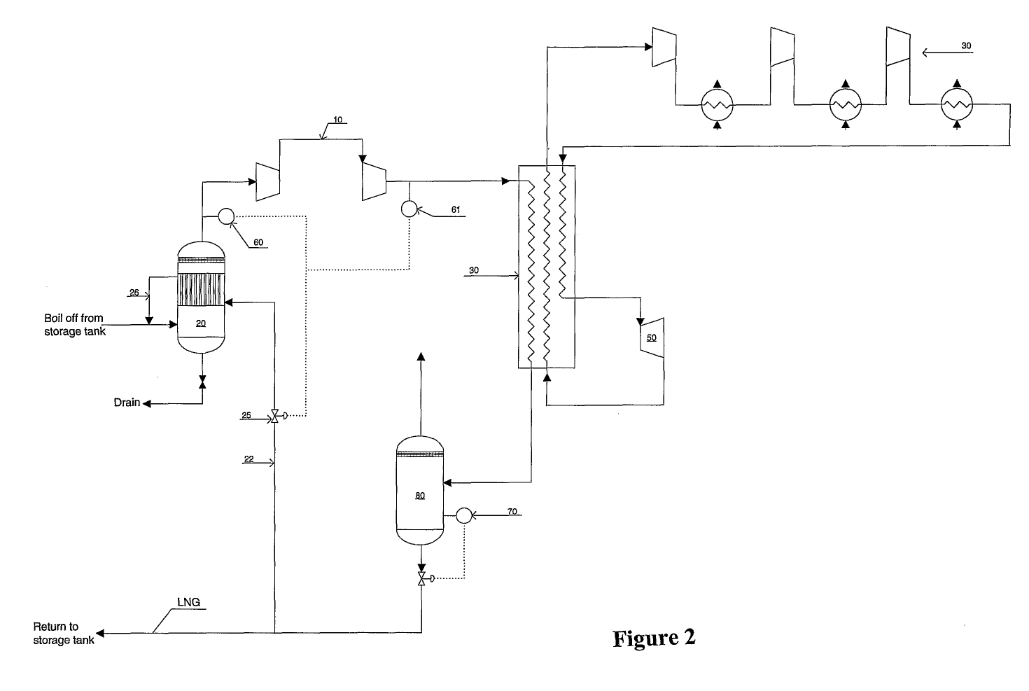

FIG. 2 is a principle flow diagram of a liquefaction plant incorporating one embodiment of the apparatus according to the invention.

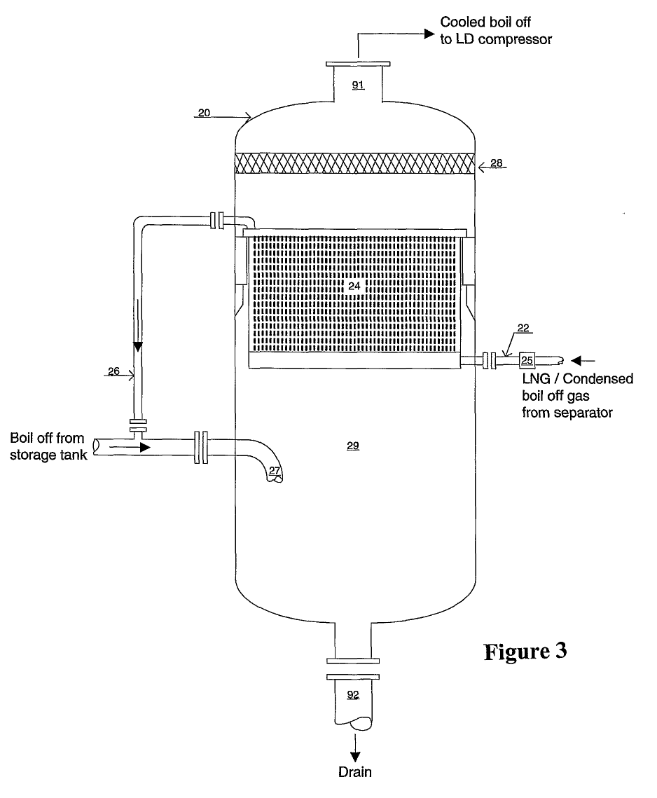

FIG. 3 is a principle sketch of the combined mist separator and heat exchanger according to the invention.

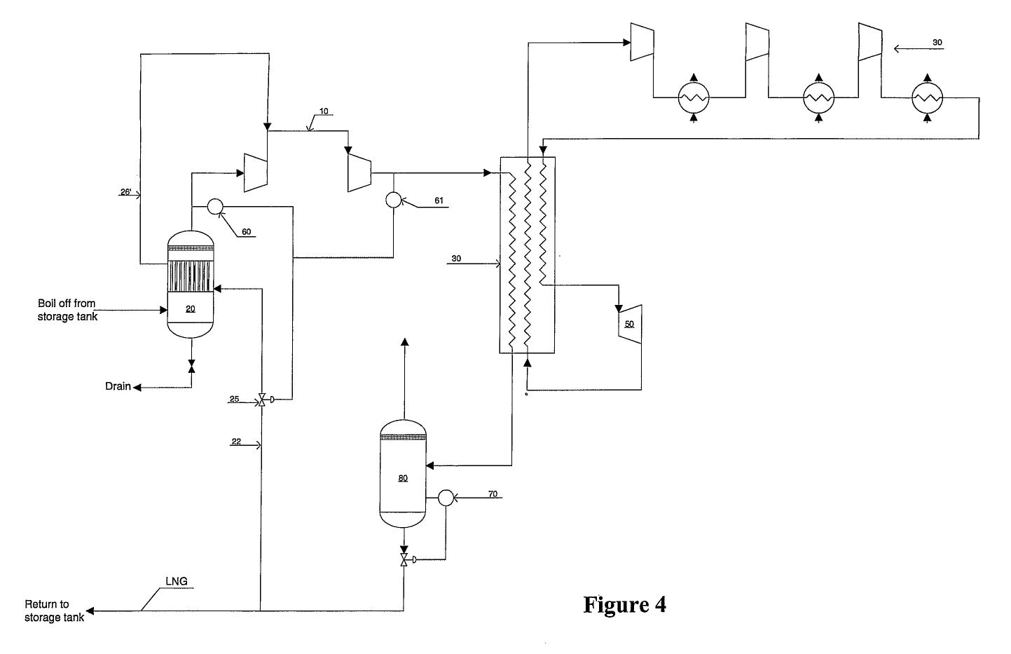

FIG. 4 is a principle flow diagram of a liquefaction plant incorporating an alternative embodiment of the apparatus according to the invention.

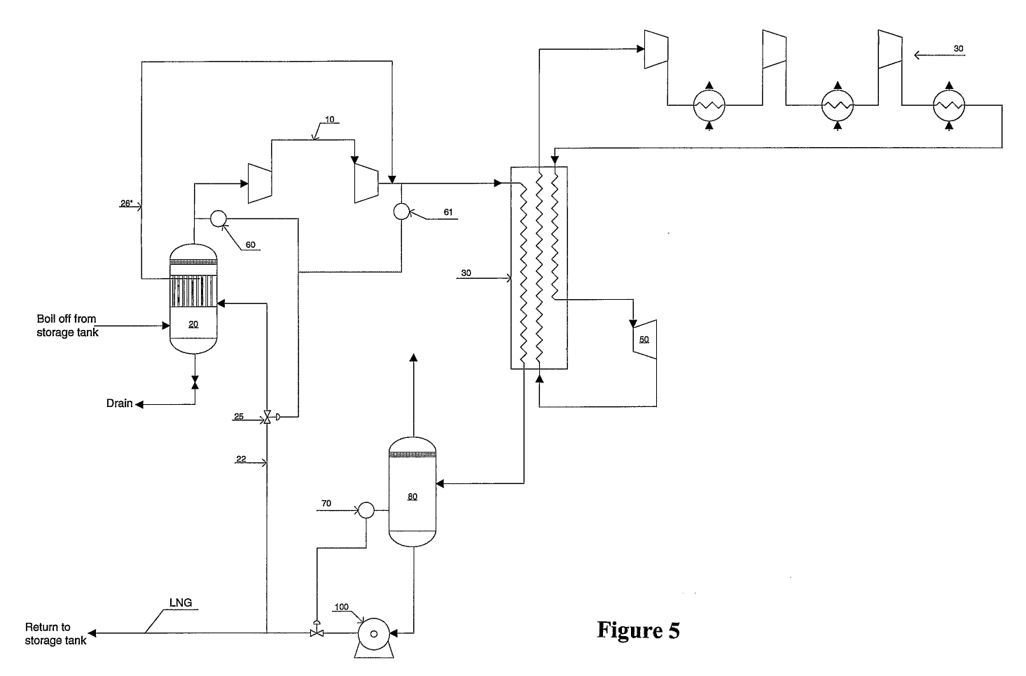

FIG. 5 is a principle flow diagram of a liquefaction plant incorporating another alternative embodiment of the apparatus according to the invention.

In FIG. 2, a liquefaction plant incorporating the apparatus according to the invention is shown. Evaporated LNG (i.e. boil-off gases) flows from a storage tank (not shown) and into the plant. In the customary fashion, the boil-off gas is compressed in the LD compressor 10. Like for the prior art system, the boil-off gas is then cooled against a coolant (e.g. nitrogen gas) in the cryogenic heat exchanger (“cold box”) 30. The coolant is managed by the circuit on the right-hand side of the cold box, comprising the multi-stage compressor 40 with intermediate coolers, and the expander 50, as the skilled reader readily will recognize.

The cold box 30 produces LNG, but the boil-off gas may not have been completely liquefied: Some portions of gas (predominantly nitrogen and some small amounts of methane) remain together with the LNG flowing out of the cold box. Hence, the nitrogen separator 80 and the associated control unit 70 are customarily included in the circuit.

Subsequent of any necessary and desirable process steps, as may vary depending on the application, LNG is returned to the storage tank. This is indicated at the lower left-hand side of FIG. 2.

The invention comprises the combined mist separator and heat exchanger 20 connected to the the boil-off gas feed line, between the LNG storage tank and the compressor 10. As shown in FIG. 2, a conduit 22 fluidly connects the line for returning LNG to the storage tank and the heat exchanger 20. A second conduit 26 fluidly connects the heat exchanger 20 to the boil-off gas feed line at a point upstream of the heat exchanger 20.

Turning now to FIG. 3, key parts of the heat exchanger 20 are shown. It generally comprises a separation chamber 29 holding a cooler 24; in this embodiment, a pipe cooler. LNG/condensed boil-off from the nitrogen separator is fed into the cooler via the conduit 22. Boil-off gas from the storage tank if fed into the chamber 29 via the inlet 27. The boil-off gas, which as stated above may hold a temperature as high as −40° C., is then cooled in heat exchange with the LNG flowing through the cooler 24. The cooled boil-off gas is evacuated from the chamber through the outlet 91. A mesh screen 28, as a precaution against droplets inadvertently entering the compressors, is also shown.

LNG flowing into the cooler 24 may have a temperature in the order of e.g. −159° C. The LNG will evaporate completely in the cooler 24 during heat exchange with boil-off gas.

The evaporated natural gas flowing out of the cooler 24, is injected into the boil-off stream as shown in FIG. 3—at a rate controlled by the valve 25, and fed into the chamber 29 as described above. Any residual liquids that might occur during first start up and start up after dry docking will gravitate out of the chamber 29 through the drain 92.

The mist separator section of the combined unit is particularly required during first start up, after dry docking and to protect the compressor 10 in case of failure in the valve 25.

In order to keep the temperature in the boil-off gas entering the cold box and compressor within a predetermined range (as indicated above), the temperature is measured downstream of the heat exchanger 20 and also downstream of compressor 10 (as shown in FIG. 2, indicated by reference numeral 61) and the control valve (choke valve) 25 in the conduit 22 is thus adjusted by the control unit 60. Thereby, the flow rate through the conduit 22 and into the combined mist separator and heat exchanger is controlled.

FIG. 4 illustrates an alternative embodiment of the apparatus according to the invention. As an alternative to mixing the fully evaporated LNG from conduit 26 with the boil off gas feed line upstream of the combined mist separator and heat exchanger (as shown in FIG. 2), is to route conduit 26′ to the discharge of the first compression stage of compressor 10. This may result in marginal power savings.

FIG. 5 illustrates another alternative embodiment of the apparatus according to the invention. As an alternative to mixing the fully evaporated LNG from conduit 26 with the boil off gas feed line upstream of the combined mist separator and heat exchanger (as shown in FIG. 2), is to route the conduit 26″ to the discharge of the compressor 10. This alternative requires the LNG return pump 100, illustrated downstream of the nitrogen separator 80.

With the novel method, a continuous flow of LNG and boil-off gas in said heat exchange is maintained, whereby the LNG temperature is substantially constant. The mixing rate is controlled based on comparing the temperature of the boil-off gas downstream of said heat exchange, with a predetermined temperature or range of temperatures.

As described above, in one embodiment a control unit 60 is connected to the control valve 25 and the boil-off gas feed line downstream of the combined mist separator and heat exchanger 20 and upstream of said compressor 10. A control unit 61 is connected to the control valve 25 and the boil-off gas feed line upstream of the cold box 30 and down stream of said compressor 10. Thus, the LNG flow rate into the combined mist separator and heat exchanger 20 is controllable based on the sensed temperatures of the boil-off gas in the feed line downstream said combined mist separator and heat exchanger 20 and downstream said compressor 10.

The invented apparatus does not require any major alterations to the liquefaction plant. The BOG compressors, associated gears, etc. may also be of the same size as with the prior art plants. Although the cooler 24 is depicted as a pipe cooler, the skilled person will appreciate that any suitable cooler may be used.

With the present invention, a selected temperature or range of temperatures—for example determined by the compressor characteristics—may be used as a controlling parameter for the choke valve in order to control the flow through the cooler and into the boil-off gas feed line upstream of the heat exchanger.

1. A method for controlling temperature in a boil-off gas in a liquefaction plant prior to compression, wherein boil-off gas originating from an LNG storage tank is compressed and at least partially condensed, and wherein said condensed boil-off gas (LNG) is being returned to the storage tank, said method being
characterized by: heat exchanging boil-off gas with said LNG, wherein the boil-off gas temperature is lowered and said LNG fully evaporated; and controllably mixing said fully evaporated LNG with said boil-off gas.

2. The method of claim 1, characterized by mixing said fully evaporated LNG with said boil-off gas upstream of said heat exchange.

3. The method of claim 1, characterized by mixing said fully evaporated LNG with said boil-off gas during said compression.

4. The method of claim 1, characterized by mixing said fully evaporated LNG with said boil-off gas following said compression.

5. The method of claim 1, characterized by maintaining a continuous flow of LNG and boil-off gas in said heat exchange, whereby the LNG temperature is substantially constant.

6. The method of claim 1, characterized by controlling (25,60) the mixing rate based on comparing the temperature of the boil-off gas downstream of said heat exchange, with a predetermined temperature or range of temperatures.

7. An apparatus for controlling temperature in a boil-off gas in a liquefaction plant prior to compression, wherein boil-off gas from an LNG storage tank is fed via a feed line into at least one compressor (10) and where the compressed gas is further fed into a heat exchanger (30) for at least partial condensation, and where said condensed boil-off gas (LNG) is being returned to the storage tank via a return line, said apparatus being
characterized by
a combined mist separator and heat exchanger (20) connected to the the boil-off gas feed line, between the LNG storage tank and the compressor (10);
a first conduit (22) fluidly connecting the line for returning LNG to the storage tank and the combined mist separator and heat exchanger (20);
a second conduit (26; 26′; 26″) fluidly connecting the combined mist separator and heat exchanger (20) to the boil-off gas feed line;
said first (22) and second (26;26′; 26″) conduits being fluidly connected via a cooler (24) in said combined mist separator and heat exchanger (20), and
wherein the boil-off gas is heat exchanged against said cooler (24) prior to being fed into said compressor (10).

8. The apparatus of claim 7, characterized by said second conduit (26) fluidly connecting the combined mist separator and heat exchanger (20) to the boil-off gas feed line upstream of said combined mist separator and heat exchanger (20).

9. The apparatus of claim 7, characterized by said second conduit (26′) fluidly connecting the combined mist separator and heat exchanger (20) to the boil-off gas feed line after the first compression stage of said compressor (10).

10. The apparatus of claim 7, characterized by said second conduit (26″) fluidly connecting the combined mist separator and heat exchanger (20) to the boil-off gas feed line downstream of said compressor (10).

11. The apparatus of claim 7, characterized by a control valve (25) in said first conduit (22), for controlling the LNG flow rate into the combined mist separator and heat exchanger (20).

12. The apparatus of claim 7, characterized by a control unit (60) connected to the control valve (25) and the boil-off gas feed line downstream of the combined mist separator and heat exchanger (20) and upstream of said compressor (10), a control unit(61) connected to the control valve (25) and the boil-off gas feed line upstream of the cold box (30) and down stream of said compressor (10) whereby the LNG flow rate into the combined mist separator and heat exchanger (20) is controllable based on the sensed temperatures of the boil-off gas in the feed line downstream said combined mist separator and heat exchanger (20) and downstream said compressor (10).

13. The apparatus of claim 7, characterized in that the combined mist separator and heat exchanger (20) additionally comprises a boil-off gas inlet (27), a chamber (29) and a drain (92) upstream of said cooler (24), and a mesh screen (28) between said heat exchanger (24) and an outlet (91), whereby boil-off gas is cooled by heat exchange with the cooler (24).
